(19) United States
(12) Patent Application Publication
(10) Pub. No.: US 2026/0017543 A1
(43) Pub. Date: Jan. 15, 2026

(54) LARGE MODEL-BASED INFORMATION PROCESSING

(71) Applicant: BEIJING BAIDU NETCOM SCIENCE TECHNOLOGY CO., LTD., Beijing (CN)

(72) Inventors: Siqi BAO, Beijing (CN); Xin TIAN, Beijing (CN); Bingjin CHEN, Beijing (CN); Jingzhou HE, Beijing (CN); Yu SUN, Beijing (CN); Hao TIAN, Beijing (CN); Hua WU, Beijing (CN); Haifeng WANG, Beijing (CN)

(73) Assignee: BEIJING BAIDU NETCOM SCIENCE TECHNOLOGY CO., LTD., Beijing (CN)

(21) Appl. No.: 19/330,673

(22) Filed: Sep. 16, 2025

(30) Foreign Application Priority Data
Jun. 19, 2025 (CN) 202510830476.6

(51) Int. Cl. G06N 5/04; G06F 40/284; G06F 40/40

(52) U.S. Cl. CPC G06N 5/04; G06F 40/40; G06F 40/284

(57) ABSTRACT

A large model-based information processing method, an apparatus, a device, and a medium are provided, which relate to the technical field of artificial intelligence, particularly to the technical fields of machine learning, deep learning, large models and the like. The method includes: obtaining a user input; determining a target working mode from a plurality of predefined working modes, where each predefined working mode has a corresponding inference strategy and is provided with a mode control identifier for triggering the inference strategy; and inputting the user input and the mode control identifier of the target working mode into the large model to obtain target output data generated by the large model based on the inference strategy of the target working mode.

### CROSS REFERENCE TO RELATED APPLICATION

This application claims priority to Chinese Patent Application No. 202510830476.6, filed on Jun. 19, 2025, the contents of which are hereby incorporated by reference in their entirety for all purposes.

### TECHNICAL FIELD

The present disclosure relates to the technical field of artificial intelligence, particularly to the technical fields of machine learning, deep learning, large models and the like, and specifically to a large model-based information processing method, a large model-based information processing apparatus, an electronic device, a computer-readable storage medium, and a computer program product.

### BACKGROUND

Artificial intelligence is the discipline of studying how computers can simulate certain thinking processes and intelligent behaviors of a human being (such as learning, reasoning, thinking, planning, etc.), and there are both hardware-level and software-level technologies. The artificial intelligence hardware technologies generally include technologies such as sensors, special artificial intelligence chips, cloud computing, distributed storage, big data processing, etc. The artificial intelligence software technologies mainly include natural language processing technology, computer vision technology, speech recognition technology, machine learning/deep learning, big data processing technology, knowledge graph technology and other major technological directions.

With the rapid development of large language models (LLM), large models that support inference have achieved significant results in multiple tasks. Such a model can generate intermediate steps of the inference process, decompose a complex problem into a plurality of sub-problems, progressively validate the inference chain, and provide the basis for subsequent response content. Subsequently, the large model for generation can complete the final output based on the inference result. This approach not only enhances the accuracy of the output content but also visually presents the inference process to the user such that the output is more structured and interpretable, thereby improving the credibility of the output content.

The methods described in this section are not necessarily methods that have been previously conceived or employed. Unless otherwise indicated, it should not be assumed that any method described in this section is considered to be the prior art only due to its inclusion in this section. Similarly, the problems mentioned in this section should not be assumed to be recognized in any prior art unless otherwise indicated.

### SUMMARY

The present disclosure provides a large model-based information processing method, a large model-based information processing apparatus, an electronic device, a computer-readable storage medium, and a computer program product.

According to one aspect of the present disclosure, a large model-based information processing method is provided. The method includes: obtaining a user input; determining a target working mode from a plurality of predefined working modes, where each predefined working mode has a corresponding inference strategy and is provided with a mode control identifier for triggering the inference strategy; and inputting the user input and the mode control identifier of the target working mode into the large model to obtain target output data generated by the large model based on the inference strategy corresponding to the target working mode.

According to another aspect of the present disclosure, a large model-based information processing apparatus is provided. The apparatus includes: an obtaining unit configured to obtain a user input; a determination unit configured to determine a target working mode from a plurality of predefined working modes, where each predefined working mode has a corresponding inference strategy and is provided with a mode control identifier for triggering the inference strategy; and a text generation unit configured to input the user input and the mode control identifier of the target working mode into the large model to obtain target output data generated by the large model based on the inference strategy corresponding to the target working mode.

According to another aspect of the present disclosure, an electronic device is provided, including: one or more processors; a memory storing one or more programs configured to be executed by the one or more processors, the one or more programs including instructions for: obtaining a user input; determining a target working mode from a plurality of predefined working modes, wherein each predefined working mode is associated with a corresponding inference strategy and a mode control identifier for triggering the corresponding inference strategy; and inputting the user input and the mode control identifier of the target working mode into the large model to obtain target output data generated by the large model based on the inference strategy corresponding to the target working mode.

According to another aspect of the present disclosure, a non-transient computer-readable storage medium storing one or more programs, the one or more programs comprising instructions, which when executed by one or more processors of an electronic device, cause the electronic device to: obtain a user input; determine a target working mode from a plurality of predefined working modes, wherein each predefined working mode is associated with a corresponding inference strategy and a mode control identifier for triggering the corresponding inference strategy; and input the user input and the mode control identifier of the target working mode into the large model to obtain target output data generated by the large model based on the inference strategy corresponding to the target working mode.

According to one or more embodiments of the present disclosure, by providing dedicated mode control identifier for a plurality of predefined working modes with different inference strategies respectively and inputting the user input together with the corresponding mode control identifier into the large model in generation stage, the present disclosure enables the large model to automatically identify and perform the inference strategy corresponding to the selected working mode. Through this approach, a single large model can support a plurality of working modes with different inference strategies and can flexibly make a selection according to specific scenarios, thereby enhancing the adaptability of the large model to user requirements and the generation efficiency, and reducing the costs associated with training, deploying, and maintaining a plurality of models for different inference strategies.

It should be understood that the content described in this section is not intended to identify key or important features of the embodiments of the present disclosure, nor is it intended to limit the scope of the present disclosure. Other features of the present disclosure will become readily understood from the following description.

### BRIEF DESCRIPTION OF THE DRAWINGS

The drawings exemplarily illustrate embodiments and constitute a part of the specification, and are used in conjunction with the textual description of the specification to explain the example implementations of the embodiments. The illustrated embodiments are for illustrative purposes only and do not limit the scope of the claims. Throughout the drawings, like reference numerals refer to similar but not necessarily identical elements.

FIG. 1 illustrates a schematic diagram of an example system in which various methods described herein can be implemented according to example embodiments of the present disclosure;

FIG. 2 illustrates a flowchart of a large model-based information processing method according to an embodiment of the present disclosure;

FIG. 3 illustrates a flowchart of a training operation for a large model according to an embodiment of the present disclosure;

FIG. 4 illustrates a structural block diagram of a large model-based information processing apparatus according to an embodiment of the present disclosure; and

FIG. 5 illustrates a structural block diagram of an example electronic device that can be used to implement the embodiments of the present disclosure.

### DETAILED DESCRIPTION OF THE EMBODIMENTS

The example embodiments of the present disclosure are described below in conjunction with the accompanying drawings, including various details of the embodiments of the present disclosure to facilitate understanding, and they should be considered as example only. Therefore, one of ordinary skill in the art will recognize that various changes and modifications may be made to the embodiments described herein without departing from the scope of the present disclosure. Similarly, descriptions of well-known functions and structures are omitted in the following description for the purpose of clarity and conciseness.

In the present disclosure, unless otherwise specified, the terms “first “,” second “and the like are used to describe various elements and are not intended to limit the positional relationship, timing relationship, or importance relationship of these elements, and such terms are only used to distinguish one element from another. In some examples, the first element and the second element may refer to the same instance of the element, while in some cases they may also refer to different instances based on the description of the context.

The terminology used in the description of the various examples in this disclosure is for the purpose of describing particular examples only and is not intended to be limiting. Unless the context clearly indicates otherwise, if the number of elements is not specifically defined, the element may be one or more. In addition, the terms “and/or” used in the present disclosure encompass any one of the listed items and all possible combinations thereof.

Embodiments of the present disclosure will be described in detail below with reference to the accompanying drawings.

In related art, some implementations adopt different independent models for different inference strategies. However, the training, deployment, and maintenance costs of a plurality of model architectures increase exponentially.

To address the above problems, the present disclosure enables the large model to automatically identify and perform the inference strategy corresponding to the selected working mode by providing dedicated mode control identifier for a plurality of predefined working modes with different inference strategies respectively and inputting the user input together with the corresponding mode control identifier into the large model in generation stage. Through this approach, a single large model can support a plurality of working modes with different inference strategies and can flexibly make a selection according to specific scenarios, thereby enhancing the adaptability of the large model to user requirements and the generation efficiency, and reducing the costs associated with training, deploying, and maintaining a plurality of models for different inference strategies.

Embodiments of the present disclosure will be described in detail below with reference to the accompanying drawings.

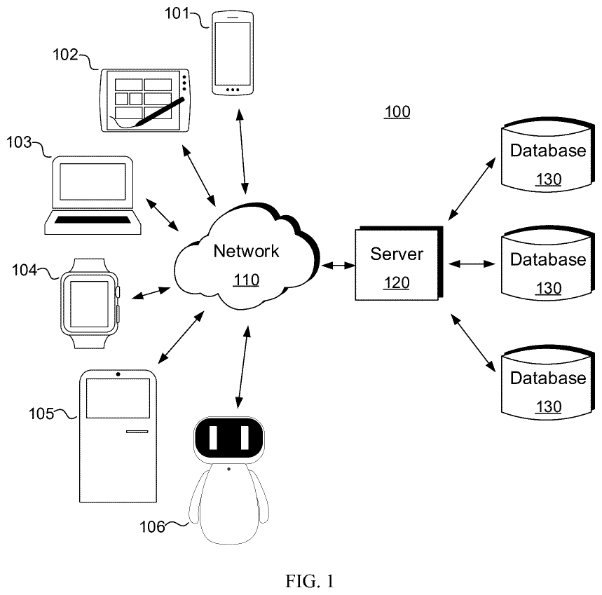

FIG. 1 illustrates a schematic diagram of an example system 100 in which various methods and apparatuses described herein may be implemented in accordance with embodiments of the present disclosure. Referring to FIG. 1, the system 100 includes one or more client devices 101, 102, 103, 104, 105 and 106, a server 120, and one or more communication networks 110 that couple one or more client devices to the server 120. The client devices 101, 102, 103, 104, 105, and 106 may be configured to execute one or more applications.

In embodiments of the present disclosure, the server 120 may run one or more services or software applications that enable execution of the data processing method or the model training method.

In some embodiments, the server 120 may also provide other services or software applications, which may include non-virtual environments and virtual environments. In some embodiments, these services may be provided as web-based services or cloud services, such as to the user of the client devices 101, 102, 103, 104, 105, and/or 106 under a Software as a Service (Saas) model.

In the configuration shown in FIG. 1, the server 120 may include one or more components that implement functions performed by the server 120. These components may include software components, hardware components, or a combination thereof that are executable by one or more processors. A user operating the client devices 101, 102, 103, 104, 105, and/or 106 may sequentially utilize one or more client applications to interact with the server 120 to utilize the services provided by these components. It should be understood that a variety of different system configurations are possible, which may be different from the system 100. Therefore, FIG. 1 is an example of a system for implementing the various methods described herein and is not intended to be limiting.

The user may use the client devices 101, 102, 103, 104, 105, and/or 106 to conduct human-machine interaction. The client devices may provide an interface that enables the user of the client devices to interact with the client devices. The client devices may also output information to the user via the interface. Although FIG. 1 depicts only six client devices, those skilled in the art will be able to understand that the present disclosure may support any number of client devices.

The client devices 101, 102, 103, 104, 105, and/or 106 may include various types of computer devices, such as portable handheld devices, general-purpose computers, such as personal computers and laptop computers, workstation computers, wearable devices, smart screen devices, self-service terminal devices, service robots, gaming systems, thin clients, various messaging devices, sensors, or other sensing devices, and the like. These computer devices may run various types and versions of software applications and operating systems, such as Microsoft Windows, Apple IOS, Unix-like operating systems, Linux or Linux-like operating systems (e.g., Google Chrome OS); or include various mobile operating systems, such as Microsoft Windows Mobile OS, iOS, Windows Phone, Android. The portable handheld devices may include cellular telephones, smart phones, tablet computers, personal digital assistants (PDAs), and the like. The wearable devices may include head-mounted displays, such as smart glasses, and other devices. The gaming systems may include various handheld gaming devices, Internet-enabled gaming devices, and the like. The client devices can perform various different applications, such as various applications related to the Internet, communication applications (e.g., e-mail applications), Short Message Service (SMS) applications, and may use various communication protocols.

The network 110 may be any type of network well known to those skilled in the art, which may support data communication using any of a variety of available protocols (including but not limited to TCP/IP, SNA, IPX, etc.). By way of example only, one or more networks 110 may be a local area network (LAN), an Ethernet-based network, a token ring, a wide area network (WAN), an Internet, a virtual network, a virtual private network (VPN), an intranet, an external network, a blockchain network, a public switched telephone network (PSTN), an infrared network, a wireless network (for example, Bluetooth, Wi-Fi), and/or any combination of these and/or other networks.

The server 120 may include one or more general-purpose computers, a dedicated server computer (e.g., a PC (personal computer) server, a UNIX server, a mid-end server), a blade server, a mainframe computer, a server cluster, or any other suitable arrangement and/or combination. The server 120 may include one or more virtual machines running a virtual operating system, or other computing architectures involving virtualization (e.g., one or more flexible pools of a logical storage device that may be virtualized to maintain virtual storage devices of a server). In various embodiments, the server 120 may run one or more services or software applications that provide the functions described below.

The computing unit in the server 120 may run one or more operating systems including any of the operating systems described above and any commercially available server operating system. The server 120 may also run any of a variety of additional server applications and/or intermediate layer applications, including an HTTP server, an FTP server, a CGI server, a Java server, a database server, etc.

In some implementations, the server 120 may include one or more applications to analyze and merge data feeds and/or event updates received from the user of the client devices 101, 102, 103, 104, 105, and/or 106. The server 120 may also include one or more applications to display the data feeds and/or the real-time events via one or more display devices of the client devices 101, 102, 103, 104, 105, and/or 106.

In some embodiments, the server 120 may be a server of a distributed system, or a server incorporating a blockchain. The server 120 may also be a cloud server, or an intelligent cloud computing server or an intelligent cloud host with an artificial intelligence technology. The cloud server is a host product in a cloud computing service system to overcome the defects of management difficulty and weak service expansibility existing in a traditional physical host and virtual private server (VPS) service.

The system 100 may also include one or more databases 130. In certain embodiments, these databases may be used to store data and other information. For example, one or more of the databases 130 may be used to store information such as audio files and video files. The databases 130 may reside in various locations. For example, the database used by the server 120 may be local to the server 120, or may be remote from the server 120 and may communicate with the server 120 via a network-based or dedicated connection. The databases 130 may be of different types. In some embodiments, the database used by the server 120 may be, for example, a relational database. One or more of these databases may store, update, and retrieve data to and from the database in response to a command.

In some embodiments, one or more of the databases 130 may also be used by an application to store application data. The databases used by the application may be different types of databases, such as a key-value repository, an object repository, or a conventional repository supported by a file system.

The system 100 of FIG. 1 may be configured and operated in various ways to enable application of various methods and apparatuses described according to the present disclosure.

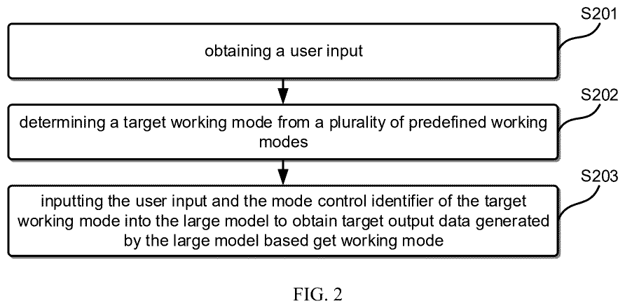

According to one aspect of the present disclosure, a large model-based information processing method is provided. As shown in FIG. 2, the method includes: step S201, obtaining a user input;

step S202, determining a target working mode from a plurality of predefined working modes, where each predefined working mode has a corresponding inference strategy and is provided with a mode control identifier for triggering the inference strategy; and step S203, inputting the user input and the mode control identifier of the target working mode into the large model to obtain target output data generated by the large model based on the inference strategy corresponding to the target working mode.

Therefore, by providing dedicated mode control identifier for a plurality of predefined working modes with different inference strategies respectively and inputting the user input together with the corresponding mode control identifier into the large model in generation stage, the large model is enabled to automatically identify and perform the inference strategy corresponding to the selected working mode. Through this approach, a single large model can support a plurality of working modes with different inference strategies and can flexibly make a selection based on the specific scenario, thereby enhancing the adaptability of the large model to user requirements and the generation efficiency, and reducing the costs associated with training, deploying, and maintaining a plurality of models for different inference strategies.

The large model (or a deep learning large model) described in the present disclosure can be a large language model. The deep learning large model has end-to-end characteristic, and it can directly generate response data based on user's input data without relying on functional components or other inputs other than the deep learning large model. In other words, the deep learning large model itself has a generation function. Large language models typically refer to deep learning large models with billions or even trillions of parameters, which are typically trained on large-scale text data or data of other modalities. Large language models can be used for various natural language processing tasks, such as text generation, language translation, and a question-answering system.

A deep learning large model can adopt, for example, an N-layer Transformer network structure with an encoder (Encoder) and a decoder (Decoder), or a Unified Pre-trained Language Model (UniLM) network structure. It should be understood that the deep learning large model may also be other Transformer network structure-based neural network model, and this is not limited herein. Both the input and the output of the deep learning large model consist of tokens (also known as tokens). Each token can correspond to a single character, a letter, a word, or a special symbol. The deep learning large model can be trained using a pre-training task and a generation task to have the generation function described above.

The large model described in the present disclosure may also be a multimodal large model. The input of the multimodal large model can include not only text data but also various types of information such as images, audios, and videos, and the multimodal large model has the capability of processing cross-modal information. The multimodal large model typically enables, by performing unified encoding and modeling on data of different modalities, the model to understand and integrate various information sources, thereby implementing more complex inference and generation tasks. Accordingly, the output of the multimodal large model is not limited to text form but can also include image generation, speech synthesis, video summary generation, and the like.

In a multimodal scenario, a token can further represent a modal unit such as an image block, an audio frame etc., for unified representing and processing non-textual information. In step S201, obtaining a user input.

The user input in the present disclosure may include various types of external information that can be processed by the large model, including text, audios, images, or other types of information actively input by the user, and may also include content automatically filled in by the system based on the user information or obtained by other means. In an example embodiment, the user input can be user query (Query) data.

In step S202, determining a target working mode from a plurality of predefined working modes, where each predefined working mode has a corresponding inference strategy and is provided with a mode control identifier for triggering the inference strategy.

In some embodiments, the plurality of predefined working modes may correspond to various inference strategies such as performing an inference, skipping the inference, and allowing the large model to autonomously determine whether to perform the inference, and the like, respectively. Where, the “performing an inference” may require the large model to forcibly perform an inference process, the “skipping the inference” may force the large model to skip the inference process, and the “large model autonomously determining” may allow the large model to autonomously determine whether to perform the inference process based on the user input. Implementation details of each of the foregoing modes are described below. Each of the foregoing modes implements the control of the large model through the corresponding mode control identifier. It can be understood that any inference strategy that determines the inference processing approach of the large model before generating the response data for the user input using a mode control identifier can be considered as an inference strategy of the present disclosure.

The mode control identifier can employ a natural language or employ a specific formatted symbol or tag (the specific form is described below), for controlling the large model to perform generation according to the corresponding inference strategy.

In step S203, inputting the user input and the mode control identifier of the target working mode into the large model to obtain target output data generated by the large model based on the inference strategy corresponding to the target working mode.

In some embodiments, the user input and the mode control identifier can first be combined to form input data for the large model, and then the input data is processed by the large model. In some scenarios, the input data for the large model is also referred to as a prompt or prompt text (prompt).

In some embodiments, the user input and the mode control identifier can be concatenated to obtain the input data for the large model. Additionally, a string representing the user side can be provided before the user input, and a string representing the machine side can be provided before the mode control identifier. A logical separation identifier can also be provided between the user input and the string representing the machine side.

In an example embodiment, the input data for the large model can be: User: {user input} \nAssistant: {mode control identifier} where, the “User:” is the string representing the user side, the “In” is the newline character, i.e., the logical separation, and the “Assistant:” is the string representing the machine side.

The large model can generate the output data using an autoregressive approach. Specifically, the input data (e.g., including the user input and the mode control identifier) can first be tokenized (tokenization) to obtain a sequence of tokens. Furthermore, the sequence of tokens can be processed using the large model, and the newly generated tokens are input into the large model through iteration to finally obtain the output data generated by the large model. Thereby, the input data (i.e., the prompt) and the output data (the sequentially generated multiple tokens) can form a complete sequence.

In some embodiments, the user input and the control identifier are sequentially input into the large model, and the target output data is generated by the large model, after the mode control identifier is input, by continuing generation from the mode control identifier. “Continuing” can be understood as the generation behavior of the large model in which, after the token sequence corresponding to the input data has been pre-filled, the large model generates tokens immediately following the last token of the input data. Therefore, in the above complete sequence, the mode control identifier and the output data are contiguous. The multiple tokens generated by the large model by continuing from the mode control identifier include multiple tokens belonging to the response data, and depending on the differences of the inference strategies, may also include one or more tokens belonging to the inference process text that precede the response data. Additionally, the response data may also include specifically formatted symbols or tags.

According to some embodiments, the respective mode control identifier of the plurality predefined working modes are each set to include a unified inference start identifier, and indicate the large model to trigger the corresponding inference strategy by appending or omitting a subsequent identifier after the inference start identifier, where the subsequent identifier include an inference end identifier and/or a logical separation identifier

Thus, by employing a unified inference start identifier and distinguishing each working mode solely by appending or omitting a subsequent identifier, the different working modes are enabled to have a unified mode control identifier format, which enables the large model to quickly and reliably identify the corresponding working mode and inference strategy, simplifies the identifier analysis logic of the large model, reduces the data processing complexity of the training and inference stages, and enhances the stability of mode selection.

The inference start identifier can be understood as an identifier that guides or instructs the large model to enter the inference stage, and the inference end identifier can be understood as an identifier that guides or instructs the large model to exit the inference stage. Among the mode control identifiers, by appending the inference end identifier after the inference start identifier, the large model can be explicitly indicated that the inference process has ended (or no inference needs to be performed). By appending the logical separation identifier after the inference start identifier but not appending the inference end identifier, the large model can be guided to continue from the logical separation identifier to perform text content generation, thereby performing the inference process;

By omitting the subsequent identifier after the inference start identifier (i.e., not appending the inference end identifier or the logical separation identifier), the large model can also be guided into the inference phase. However, since no logical separation identifier is appended, the large model is not guided to continue to generate text content, and the large model can autonomously determine whether to directly generate an inference end identifier to skip the inference phase or generate a logical separation identifier to begin the inference process.

In an example embodiment, the inference start identifier can be “<think>”, and the inference end identifier can be “</think>”. By using customized paired XML tags, the large model is enabled to accurately identify the correspondence between the identifiers, thereby improving the parsing effect of the large model on the mode control identifier. It should be understood that the inference start identifier and the inference end identifier may employ other forms, and the present disclosure is not intended to be limiting.

According to some embodiments, the plurality of predefined working modes may include a forced inference mode. The mode control identifier corresponding to the forced inference mode may further include a logical separation identifier appended after the inference start identifier and may not include the inference end identifier. In response to the large model detecting a mode control identifier corresponding to the forced inference mode, the target output data sequentially includes an inference process text, the inference end identifier, and response data for the user input generated based on the inference process text.

Thus, for the forced inference mode, by appending the logical separation identifier after the inference start identifier but not appending the inference end identifier, the large model can be guided to generate the inference process text starting from the logical separation identifier and automatically generate an inference end identifier after the inference is completed, thereby generating the response data based on the inference process text. Since the logical separation identifier has the function of guiding the generation of text, appending the logical separation identifier can prevent the large model from continuing, in some cases, the inference start identifier to directly generate an inference end identifier to skip the inference process, thereby ensuring the large model to forcibly perform the inference process.

In the present disclosure, the “logical separation identifier” is used to identify the logical boundary of the inference process during text generation. The logical separation identifier can employ symbols or tags commonly used in text content, enabling the large model to think that it is currently in a text generation process. In an example embodiment, the logical separation identifier can be the newline character “\n”. It should be understood that any other symbol, character, or tag, besides the newline character, that is capable of implementing similar logical separation functionality may be used alternatively without departing from the scope of this disclosure.

In some embodiments, after the completion of inference process text generation, the large model can generate a logical separation identifier and generate an inference end identifier after the logical separation identifier. In other words, the target output data may further include another logical separation identifier between the inference process text and the inference end identifier. Through this approach, the inference start identifier and the logical separation identifier in the mode control identifier, as well as the inference process text, the logical separation identifier, and the inference end identifier sequentially generated by the large model form a clearly bounded and structurally symmetrical structural block to facilitate the large model and subsequent systems to perform identification, extraction, or other processing.

In an example implementation, under the forced inference mode, the input data for the large model can be:

User: {user input} \nAssistant: <think>\n where, the “<think>\n” is the mode control identifier. Accordingly, the output data of the large model can be:

{inference process text} \n</think> {response data} According to some embodiments, the plurality of predefined working modes may include a non-inference mode, and the mode control identifier corresponding to the non-inference mode may include the inference end identifier appended thereafter. In response to the large model detecting a mode control identifier corresponding to the non-inference mode, the target output data includes the response data for the user input generated by the large model after skipping the inference process.

Thus, by setting the mode control identifier corresponding to the non-inference mode to include paired inference start identifier and inference end identifier, the large model can be guided to skip the inference process and directly generate the response data, thereby achieving flexible control of the inference strategy of the large model.

In an example embodiment, under the non-inference mode, the input data for the large model can be:

User: {user input} \nAssistant: <think></think>where, the “<think></think>” is the mode control identifier. Accordingly, the output data of the large model can be:

{response data}

According to some embodiments, the plurality of predefined working modes may further include a large model autonomous inference mode, where the mode control identifier corresponding to the large model autonomous inference mode omits the subsequent identifier after the inference start identifier. In other words, the mode control identifier corresponding to the large model autonomous inference mode does not include the logical separation identifier or the inference end identifier after the inference start identifier. In response to the large model detecting a mode control identifier corresponding to the large model autonomous inference mode and the large model autonomously determining, based on the user input, that an inference process needs to be performed, the target output data sequentially includes the logical separation identifier, an inference process text, the inference end identifier, and response data for the user input generated based on the inference process text.

Thus, by providing only the inference start identifier to the large model under the large model autonomous inference mode and not providing the logical separation identifier that guides the generation of the inference process text, the large model is enabled to autonomously decide, based on the user input, whether to generate the logical separation identifier and the subsequent inference process text, thereby the large model have the capability of dynamically selecting whether to perform the inference process based on the complexity of the user input, and the allocation rationalization and generation efficiency of the inference resources are improved while the flexibility of the solution is improved.

In an example implementation, in the large model autonomous inference mode, the input data for the large model can be:

User: {user input} \nAssistant: <think>where, the “<think>” is the mode control identifier. It can be seen that compared to the forced inference mode, the input data in the large model autonomous inference mode has fewer newline characters “\n”. Therefore, in the large model autonomous inference mode, the large model can determine on its own whether to generate a logical separation identifier (e.g., the newline character “\n”) to perform the inference process or directly generate a corresponding inference end identifier (e.g., “</think>”) to skip the inference process.

When the large model determines that the inference process needs to be performed, the output data can be:

In {inference process text} \n</think> {response data}

According to some embodiments, in response to the large model detecting a mode control identifier corresponding to the large model autonomous inference mode and the large model autonomously determining, based on the user input, that no inference process needs to be performed, the target output data includes the inference end identifier and response data for the user input generated by the large model after skipping the inference process.

In an example implementation, when the large model determines that no inference process needs to be performed, the output data can be:

</think> {response data}

Unlike existing technologies that require switching independent models to implement different inference strategies, the present disclosure enables the user to flexibly switch to different inference strategies through a prefix selection approach, which sets the corresponding mode control identifier according to the desired inference strategy of the large model, thereby meeting the requirements of various scenarios and simplifying the usage process. Additionally, the large model of the present disclosure can automatically select an appropriate working mode based on the complexity of the problem, thereby maximizing the utilization of computational resources and improving the efficiency of inference while ensuring inference effectiveness.

According to some embodiments, the information processing method may further include: determining a target inference intensity. The target inference intensity may characterize a desired target length of the inference process text generated by the large model. In response to determining that the large model determines that an inference process needs to be performed, the large model can generate the inference process text based on the inference intensity.

Thus, by introducing the inference intensity as another control dimension beyond the working mode or the inference strategy, the length of the inference process text generated by the large model can be constrained to prevent the inference process from being too long and to improve the overall generation efficiency of the large model and the user experience.

In some embodiments, the inference intensity of the large model can be qualitatively controlled, for example, multiple inference intensity levels can be set such as low, medium, and high. Under different levels of inference intensities, the large model can generate an inference process text with different lengths. In some embodiments, the inference intensity of the large model can also be quantitatively controlled, for example the target length can be set as a predefined upper limit of the number of tokens.

According to some embodiments, the information processing method may further include: inputting the inference intensity as system information into the large model.

Thus, by inputting the inference intensity as system information into the large model, it is possible to influence the generation behavior of the model on the premise of not changing the input data of the large model, such that the control of the length of the inference process text is more subtle and flexible.

According to some embodiments, the large model can generate, using an autoregressive approach, the target output data based on the user input, the mode control identifier, and the generated tokens. Step S203: the inputting the user input and the mode control identifier of the target working mode into the large model to obtain the target output data generated by the large model based on the inference strategy corresponding to the target working mode may include: forcibly inputting, in response to the length of the inference process text that has been generated by the current large model exceeding a target length, an inference end identifier to the large model; and obtaining the response data for the user input generated by the large model after the inference end identifier.

Thus, by monitoring the length of the generated text (i.e., the number of generated tokens) during the inference process and forcibly inputting the inference end identifier when the inference intensity is exceeded, the length constraint of the inference process text can be achieved, thereby effectively preventing the large model from continuously generating excessively long inference content.

In an example embodiment, the inference intensity can be quantitatively controlled using an output count. For example, the user can set a specific upper limit for the number of tokens (e.g., 2,000 tokens), and when the inference process reaches the specified count, the inference process is forcibly interrupted, and “\n</think>” is appended to the end of the generated sequence, which causes the large model to output the response data.

The adjustment of inference intensity in existing technologies typically relies on the user's experience and lacks fine-grained control mechanisms. By a user and large model dual-layer inference intensity control mechanism, the present disclosure not only allows the user to flexibly adjust the inference intensity as required, but also improves the computational efficiency by autonomously controlling the computational overhead of optimized inference through the large model.

According to some embodiments, the large model can be trained using the following data: inference sample data, including a first sample input, the inference start identifier, a first inference process text, the inference end identifier, and first sample response data; and non-inference sample data, including a second sample input, the inference start identifier, the inference end identifier, and second sample response data.

In an example embodiment, the inference sample data can be represented as:

User: {first sample input} \nAssistant: <think>\n {first inference process text} \n</think> {first sample response data}

It can be seen that the inference sample data includes three parts: the user query, the inference process, and the response.

In an example embodiment, the non-inference sample data can be represented as: User: {second sample input} \nAssistant: <think></think> {second sample response data}

As can be seen, the non-inference sample data includes two parts: the user input and the response, but does not involve the inference process.

The data organization of the inference sample data and non-inference sample data is consistent with the form of the mode control identifier corresponding to each predefined working mode and the corresponding output data of the large model described above. By employing a unified data organization and training using inference sample data and non-inference sample data, the large model is enabled to, when receiving a mode control identifier corresponding to each predefined working mode, accurately identify the inference strategy currently employed and generate the matching output, thereby meeting the inference requirements in different application scenarios.

According to some embodiments, the semantic complexity of the first sample input can be greater than the semantic complexity of the second sample input. In the training phase, for a simple problem, the large model can directly output the response data without performing the inference process; for a complex problem, the large model can perform the inference process to improve the quality of the response data.

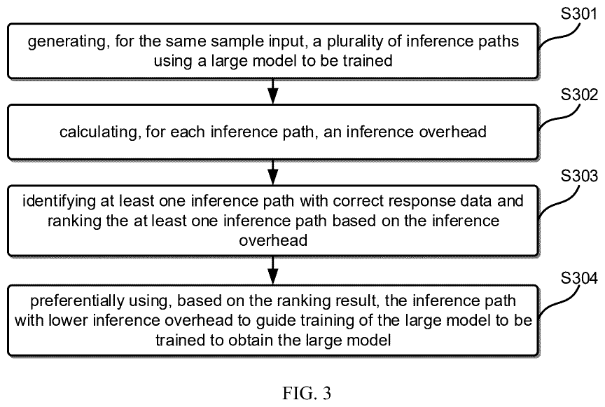

According to some embodiments, as shown in FIG. 3, the large model is trained using the following operations: step S301: generating, for the same sample input, a plurality of inference paths using the large model to be trained, where each inference path has a corresponding inference process text and response data; step S302: calculating, for each inference path, the inference overhead; step S303: identifying at least one inference path with correct response data and ranking the at least one inference path based on the inference overhead; and step S304: preferably using, based on the ranking result, the inference path with lower inference overhead to guide the training of the large model to be trained to obtain the large model.

Thus, in the reinforcement training phase, by introducing a suppression mechanism of the inference overhead, the model is encouraged to achieve similar output effects even at lower inference overhead, thereby improving the computational efficiency.

In step S301, the sample input can be the first sample input and the second sample input described above. In this step, the large model to be trained generates a plurality of candidate inference paths under the same input condition, each inference path includes a segment of inference process text and response data corresponding thereto. Different inference paths may differ in terms of the logical progression, the length, and the expression of the conclusion of the inference process. By guiding the large model to generate the plurality of alternative paths, a basis for subsequent selection of optimal training sample is provided.

In step S302, the inference overhead can be evaluated based on the length of the inference process text, the computational resources consumed during generation and the like. In an example embodiment, the overhead can be measured based on the number of tokens generated during the inference process, with more tokens indicating a longer inference path and higher overhead.

In step S303, whether the response data generated by each inference path meets the target expectation can be determined based on human annotations, rule match, or an automatic scoring mechanism. For all paths with “correct” answers, the paths can be further ranked based on the inference overhead obtained in step S302, and the path with lower overhead can be selected as a high-priority sample for subsequent training. By ranking these inference paths with “correct” answers, the model is facilitated to generate reasonable output with shorter inference path and lower cost.

In step S304, the large model to be trained can be fine-tuned by selecting, based on the ranking result, the top-ranked inference path as a supervision signal. The training objective can include maximizing the similarity between the inference result output by the model and the preferred inference path, or minimizing the deviation between the inference result output by the model and the preferred inference path. Through this approach, the trained large model can effectively balance the inference capability and the inference overhead, further improving the overall performance of the generation efficiency and the generation quality.

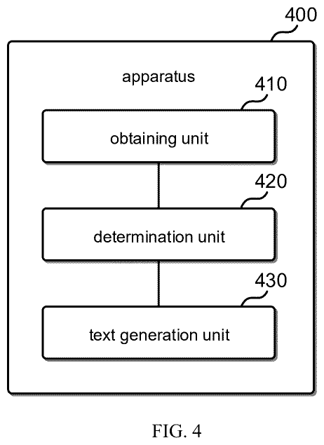

According to another aspect of the present disclosure, a large model-based information processing apparatus is provided. As shown in FIG. 4, the large model-based information processing device 400 includes: an obtaining unit 410 configured to obtain a user input; a determination unit 420 configured to determine a target working mode from a plurality of predefined working modes, where each predefined working mode has a corresponding inference strategy and is provided with a mode control identifier for triggering the inference strategy; and a text generation unit 430 configured to input the user input and the mode control identifier of the target working mode into the large model to obtain target output data generated by the large model based on the inference strategy corresponding to the target working mode.

It may be understood that, operations and effects of the unit 410-unit 430 in the apparatus 400 may refer to steps S201 to S203 in FIG. 2 respectively, and details are not repeated herein.

In the technical solution of the present disclosure, the collection, storage, use, processing, transmission, provision, and disclosure of user personal information are all in compliance with relevant laws and regulations and do not violate public order and good morals.

According to the embodiments of the present disclosure, an electronic device, a readable storage medium, and a computer program product are also provided.

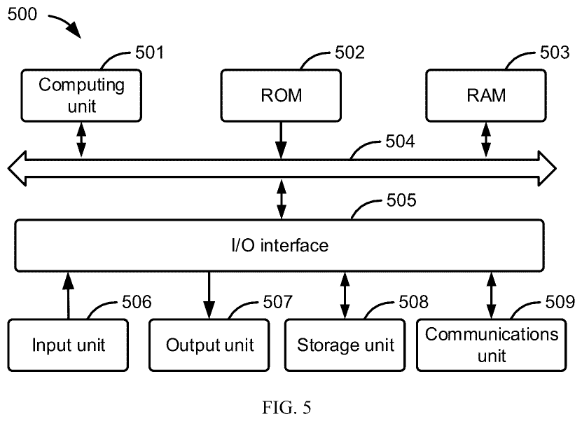

Referring to FIG. 5, a structural block diagram of an electronic device 500 that may be a server or client of the present disclosure is now described, which is an example of a hardware device that may be applied to aspects of the present disclosure. Electronic devices are intended to represent various forms of digital electronic computer devices, such as laptop computers, desktop computers, workstations, personal digital assistants, servers, blade servers, mainframe computers, and other suitable computers. The electronic devices may also represent various forms of mobile devices, such as personal digital processing, cellular telephones, smart phones, wearable devices, and other similar computing devices. The components shown herein, their connections and relationships, and their functions are merely as examples, and are not intended to limit the implementations of the disclosure described and/or claimed herein.

As shown in FIG. 5, the electronic device 500 includes a computing unit 501, which may perform various appropriate actions and processing according to a computer program stored in a read-only memory (ROM) 502 or a computer program loaded into a random access memory (RAM) 503 from a storage unit 508. In the RAM 503, various programs and data required by the operation of the electronic device 500 may also be stored. The computing unit 501, the ROM 502, and the RAM 503 are connected to each other through a bus 504. Input/output (I/O) interface 505 is also connected to the bus 504.

A plurality of components in the electronic device 500 are connected to a I/O interface 505, including: an input unit 506, an output unit 507, a storage unit 508, and a communication unit 509. The input unit 506 may be any type of device capable of inputting information to the electronic device 500, the input unit 506 may receive input digital or character information and generate a key signal input related to user setting and/or function control of the electronic device, and may include, but is not limited to, a mouse, a keyboard, a touch screen, a track pad, a trackball, a joystick, a microphone, and/or a remote control. The output unit 507 may be any type of device capable of presenting information, and may include, but are not limited to, a display, a speaker, a video/audio output terminal, a vibrator, and/or a printer. The storage unit 508 may include, but is not limited to, a magnetic disk and an optical disk. The communication unit 509 allows the electronic device 500 to exchange information/data with other devices over a computer network, such as the Internet, and/or various telecommunication networks, and may include, but is not limited to, a modem, a network card, an infrared communication device, a wireless communication transceiver and/or a chipset, such as a Bluetooth device, a 802.11 device, a Wi-Fi device, a WiMAX device, a cellular communication device, and/or the like.

Computing unit 501 may be a variety of general and/or special purpose processing components with processing and computing capabilities. Some examples of computing unit 501 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, etc. Computing unit 501 performs the various methods, processes, and/or processing described above. For example, in some embodiments, these methods, processes, and/or processing described above may be implemented as a computer software program tangibly contained in a machine-readable medium, such as the storage unit 508. In some embodiments, part or all of the computer programs may be loaded and/or installed onto the electronic device 500 via the ROM 502 and/or the communication unit 509. When the computer program is loaded to the RAM 503 and executed by the computing unit 501, one or more steps of the methods, processes, and/or processing described above may be performed. Alternatively, in other embodiments, the computing unit 501 may be configured to perform these methods, processes, and/or processing by any other suitable means (e.g., with the aid of firmware).

Various embodiments of the systems and techniques described above herein may be implemented in a digital electronic circuit system, an integrated circuit system, a field programmable gate array (FPGA), an application specific integrated circuit (ASIC), a dedicated standard product (ASSP), a system of system on a chip system (SoC), a complex programmable logic device (CPLD), computer hardware, firmware, software, and/or combinations thereof. These various embodiments may include: implementation in one or more computer programs that may be executed and/or interpreted on a programmable system including at least one programmable processor, where the programmable processor may be a dedicated or universal programmable processor that may receive data and instructions from a storage system, at least one input device, and at least one output device, and transmit data and instructions to the storage system, the at least one input device, and the at least one output device.

The program code for implementing the method of the present disclosure may be written in any combination of one or more programming languages. These program code may be provided to a processor or controller of a general-purpose computer, a special purpose computer, or other programmable data processing device such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium, which may contain or store a program for use by or in connection with an instruction execution system, device, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of a machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein may be implemented on a computer having: a display device (e.g., a CRT (cathode ray tube) or an LCD (liquid crystal display) monitor) for displaying information to a user; and a keyboard and pointing device (e.g., a mouse or trackball) by which a user may provide input to the computer. Other types of devices may also be used to provide interaction with a user; for example, the feedback provided to the user may be any form of perception feedback (e.g., visual feedback, auditory feedback, or tactile feedback); and the input from the user may be received in any form, including acoustic input, voice input, or haptic input.

The systems and techniques described herein may be implemented in a computing system including a back-end component (e.g., as a data server), or a computing system including a middleware component (e.g., an application server), or a computing system including a front-end component (e.g., a user computer with a graphic user interface or a web browser, the user may interact with implementations of the systems and techniques described herein through the graphic user interface or the web browser), or in a computing system including any combination of such back-end components, middleware components, or front-end components. The components of the system may be interconnected by digital data communication (e.g., a communications network) in any form or medium. Examples of communication networks include a local area network (LAN), a wide area network (WAN), the Internet, and a blockchain network.

The computer system may include a client and a server. Clients and servers are generally remote from each other and typically interact through a communication network. The relationship between clients and servers is generated by computer programs running on respective computers and having a client-server relationship to each other. The server may be a cloud server, or may be a server of a distributed system, or a server incorporating a blockchain.

It should be understood that the various forms of processes shown above may be used, and the steps may be reordered, added, or deleted. For example, the steps described in the present disclosure may be performed in parallel or sequentially or in a different order, as long as the results expected by the technical solutions disclosed in the present disclosure can be achieved, and no limitation is made herein.

Although embodiments or examples of the present disclosure have been described with reference to the accompanying drawings, it should be understood that the foregoing methods, systems, and devices are merely embodiments or examples, and the scope of the present disclosure is not limited by these embodiments or examples, but is only defined by the authorized claims and their equivalents. Various elements in the embodiments or examples may be omitted or may be replaced by equivalent elements thereof. Further, the steps may be performed by a different order than described in this disclosure. Further, various elements in the embodiments or examples may be combined in various ways. Importantly, with the evolution of the technology, many elements described herein may be replaced by equivalent elements appearing after the present disclosure.

1. A computer-implemented large model-based information processing method, comprising:
obtaining a user input;
determining a target working mode from a plurality of predefined working modes, wherein each predefined working mode is associated with a corresponding inference strategy and a mode control identifier for triggering the corresponding inference strategy; and
inputting the user input and the mode control identifier of the target working mode into the large model to obtain target output data generated by the large model based on the inference strategy corresponding to the target working mode.

2. The method according to claim 1, wherein the respective mode control identifiers corresponding to the plurality of predefined working modes are each configured to include a unified inference start identifier, and indicate the large model to trigger the corresponding inference strategy by appending or omitting a subsequent identifier after the unified inference start identifier, wherein the subsequent identifier include an inference end identifier and/or a logical separation identifier.

3. The method according to claim 2, wherein the plurality of predefined working modes includes a forced inference mode, and the mode control identifier corresponding to the forced inference mode includes the logical separation identifier appended after the inference start identifier and does not include the inference end identifier,
in response to the large model detecting a mode control identifier corresponding to the forced inference mode, the target output data sequentially includes an inference process text, the inference end identifier, and response data for the user input generated based on the inference process text.

4. The method according to claim 2, wherein the plurality of predefined working modes includes a non-inference mode, and the mode control identifier corresponding to the non-inference mode includes the inference end identifier appended after the inference start identifier, wherein in response to the large model detecting a mode control identifier corresponding to the non-inference mode, the target output data includes response data for the user input generated by the large model after skipping the inference process.

5. The method according to claim 2, wherein the plurality of predefined working modes includes a large model autonomous inference mode, and the mode control identifier corresponding to the large model autonomous inference mode omits the subsequent identifier after the inference start identifier,
wherein in response to the large model detecting a mode control identifier corresponding to the large model autonomous inference mode and the large model autonomously determining, based on the user input, that an inference process needs to be performed, the target output data sequentially includes the logical separation identifier, an inference process text, the inference end identifier, and response data for the user input generated based on the inference process text.

6. The method according to claim 5, wherein in response to the large model detecting a mode control identifier corresponding to the large model autonomous inference mode and the large model autonomously determining, based on the user input, that no inference process needs to be performed, the target output data includes the inference end identifier and response data for the user input generated by the large model after skipping the inference process.

7. The method according to claim 2, further comprising:
determining a target inference intensity, wherein the target inference intensity represents a desired target length of the inference process text generated by the large model, wherein in response to determining that the large model needs to perform an inference process, the large model generates the inference process text based on the inference intensity.

8. The method according to claim 7, wherein the large model generates, using an autoregressive approach, the target output data based on the user input, the mode control identifier corresponding to the target working mode, and the generated tokens, and the inputting the user input and the mode control identifier of the target working mode into the large model comprises:
forcibly inputting, in response to the length of the inference process text that has been generated by the current large model exceeding the target length, the inference end identifier to the large model; and
obtaining the response data for the user input generated by the large model after the inference end identifier.

9. The method according to claim 7, further comprising:
inputting the inference intensity as system information into the large model.

10. The method according to claim 2, wherein the large model is trained using the following data:
inference sample data, including a first sample input, the inference start identifier, a first inference process text, the inference end identifier, and first sample response data; and
non-inference sample data, including a second sample input, the inference start identifier, the inference end identifier, and second sample response data.

11. The method according to claim 10, wherein the semantic complexity of the first sample input is greater than the semantic complexity of the second sample input.

12. The method according to claim 10, wherein the large model is trained using the following operations:
generating, for the same sample input, a plurality of inference paths using a large model to be trained, wherein each inference path has a corresponding inference process text and response data;
calculating, for each inference path, an inference overhead;
identifying at least one inference path with correct response data and ranking the at least one inference path based on the inference overhead; and
preferentially using, based on the ranking result, the inference path with lower inference overhead to guide training of the large model to be trained to obtain the large model.

13. An electronic device, comprising:
one or more processors;
a memory storing one or more programs configured to be executed by the one or more processors, the one or more programs including instructions for:
obtaining a user input;
determining a target working mode from a plurality of predefined working modes, wherein each predefined working mode is associated with a corresponding inference strategy and a mode control identifier for triggering the corresponding inference strategy; and
inputting the user input and the mode control identifier of the target working mode into the large model to obtain target output data generated by the large model based on the inference strategy corresponding to the target working mode.

14. A non-transient computer-readable storage medium storing one or more programs, the one or more programs comprising instructions, which when executed by one or more processors of an electronic device, cause the electronic device to:
obtain a user input;
determine a target working mode from a plurality of predefined working modes, wherein each predefined working mode is associated with a corresponding inference strategy and a mode control identifier for triggering the corresponding inference strategy; and
input the user input and the mode control identifier of the target working mode into the large model to obtain target output data generated by the large model based on the inference strategy corresponding to the target working mode.
